(19) United States
(12) Patent Application Publication
(10) Pub. No.: US 2024/0064141 A1
(43) Pub. Date: Feb. 22, 2024

(54) INFORMATION PROCESSING DEVICE, INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Akira HIROSE, Kanagawa (JP)

(73) Assignee: FUJIFILM Business Innovation Corp., Tokyo (JP)

(21) Appl. No.: 18/177,922

(22) Filed: Mar. 3, 2023

(30) Foreign Application Priority Data
Aug. 16, 2022 (JP) 2022-129665

(51) Int. Cl. H04L 9/40

(52) U.S. Cl. CPC H04L 63/0869; H04L 63/102

(57) ABSTRACT

An information processing device includes a processor configured to: function as a virtual device that is provided one-to-one with a physical device and that mediates transmission and reception of information between an application and the physical device; and, in a case where transmission and reception of information is set to unapproved in the virtual device, prohibit transmission and reception of information to and from another application other than a connection-approved application whose connection with the virtual device is approved in advance.

### CROSS-REFERENCE TO RELATED APPLICATIONS

This application is based on and claims priority under 35 USC 119 from Japanese Patent Application No. 2022-129665 filed Aug. 16, 2022.

### BACKGROUND

### (i) Technical Field

The present disclosure relates to an information processing device, an information processing system, a non-transitory computer readable medium, and an information processing method.

### (ii) Related Art

Japanese Patent No. 6617808 discloses a remote management system including: a portal service providing apparatus including a generator configured to generate a device information obtaining request command after a service identification number of a multi-function peripheral (MFP) is registered in a remote management server, and a response unit configured to, when a usage request for a cloud service is made, responds to the usage request, including the device information obtaining request command; and a remote management server including a registration unit configured to register device information transmitted from the MFP in association with the service identification number in response to the device information obtaining request command, and a management unit configured to manage the MFP using the device information registered by the registration unit.

There has been conceivable a technique for transmitting and receiving information by performing communication between a user's application and a physical device via a virtual device provided corresponding to the physical device on the cloud. It is assumed that, even if the physical device is installed in an unintended location, the virtual device on the cloud will transmit information from the user's application to the physical device. If the physical device is incorrectly installed in an unintended location, there is a risk of information leakage from the physical device.

### SUMMARY

Aspects of non-limiting embodiments of the present disclosure relate to providing an information processing device, an information processing system, a non-transitory computer readable medium, and an information processing method capable of preventing information leakage in the case where a physical device corresponding one-to-one with a virtual device that mediates transmission and reception of information between an application and the physical device is installed in an unintended location.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device including a processor configured to: function as a virtual device that is provided one-to-one with a physical device and that mediates transmission and reception of information between an application and the physical device; and, in a case where transmission and reception of information is set to unapproved in the virtual device, prohibit transmission and reception of information to and from another application other than a connection-approved application whose connection with the virtual device is approved in advance.

### BRIEF DESCRIPTION OF THE DRAWINGS

An exemplary embodiment of the present disclosure will be described in detail based on the following figures, wherein:

FIG. 1 is a diagram illustrating a schematic configuration of an image forming system according to an exemplary embodiment;

FIG. 2 is a block diagram illustrating the configuration of the major parts of the electrical system of an image forming device in the image forming system according to the present exemplary embodiment;

FIG. 3 is a block diagram illustrating the configuration of the major parts of the electrical system of a local server, a cloud server, a client terminal, and a communication terminal in the image forming system according to the present exemplary embodiment;

FIG. 4 is a diagram for explaining a virtual device;

FIG. 5 is a diagram illustrating a situation where a real device B, which is prepared to be installed at Company α, and a real device X, which is prepared to be installed at Company Ω, are mistakenly replaced and installed;

FIG. 6 is a diagram illustrating processing performed by the virtual device in the case where a new real device is installed at Company α;

FIG. 7 is a diagram illustrating a procedure for allowing the real device to be usable from a digital system of Company α;

FIG. 8 is a diagram illustrating a state in which the virtual device and a destination table update application are enabled to communicate with each other and a destination table is transmitted to the real device;

FIG. 9 is a diagram illustrating the case where the real device X, which is prepared to be installed at Company Ω, is accidentally brought into Company α;

FIG. 10 is a flowchart illustrating an example of the flow of processing performed by the cloud server in the image forming system according to the exemplary embodiment; and

FIG. 11 is a flowchart illustrating an example of the flow of a modification of the processing performed by the cloud server in the image forming system according to the exemplary embodiment.

### DETAILED DESCRIPTION

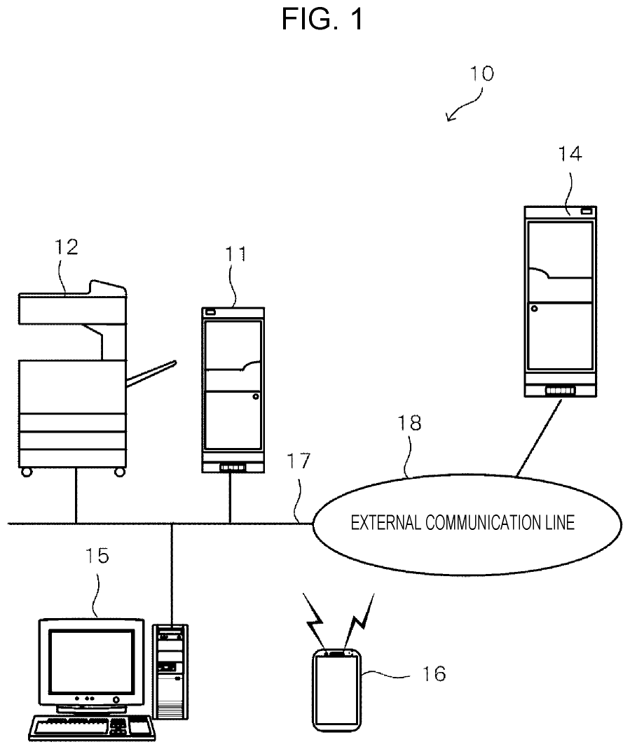

Hereinafter, an exemplary embodiment of the present disclosure will be described in detail with reference to the drawings. FIG. 1 is a diagram illustrating a schematic configuration of an image forming system according to the present exemplary embodiment. In the present exemplary embodiment, an image forming system 10 will be described as an example of an information processing system.

The image forming system 10 according to the present exemplary embodiment includes, as illustrated in FIG. 1, a local server 11, an image forming device 12 as an example of a physical device, a cloud server 14 as an example of an information processing device, a client terminal 15, and a communication terminal 16. Although only one local server 11, one image forming device 12, one cloud server 14, one client terminal 15, and one communication terminal 16 are illustrated in the present exemplary embodiment, they may be provided as plural. In addition, the local server 11 may be omitted.

The local server 11, the image forming device 12, and the client terminal 15 are connected to an internal communication line 17 such as a local area network (LAN), an intranet, or the like. The internal communication line 17 and the cloud server 14 are connected to an external communication line 18 such as a wide area network (WAN), the Internet, or the like. Moreover, the communication terminal 16 carried by a user is configured to be connectable to the internal communication line 17 and the external communication line 18. The local server 11, the image forming device 12, the cloud server 14, the client terminal 15, and the communication terminal 16 are each configured to be able to transmit and receive various types of data to and from each other via the internal communication line 17 and the external communication line 18. Note that, as an example of the communication terminal 16, a mobile phone such as a smart phone, a notebook personal computer (PC), or the like is applied, and FIG. 1 illustrates an example of a mobile phone.

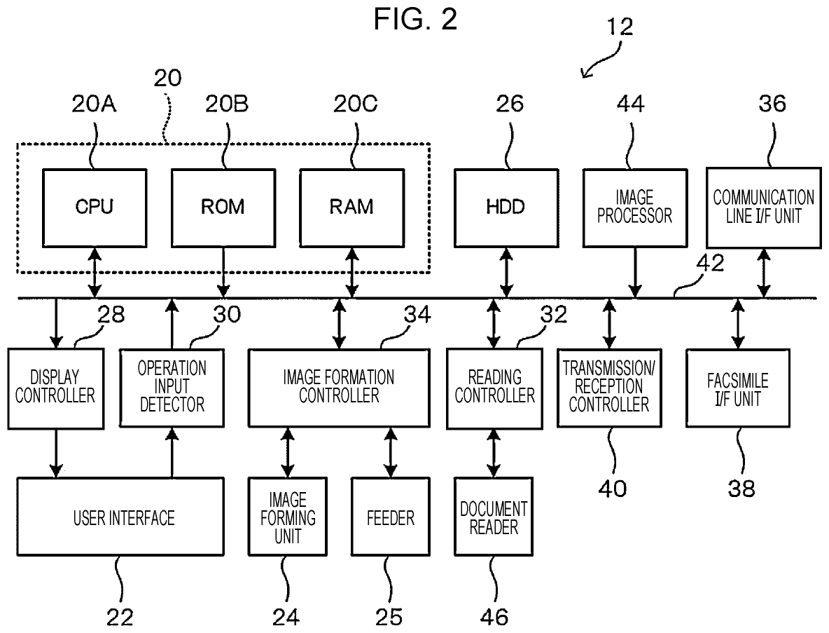

FIG. 2 is a block diagram illustrating the configuration of the major parts of the electrical system of the image forming device 12 in the image forming system 10 according to the present exemplary embodiment.

The image forming device 12 according to the present exemplary embodiment includes, as illustrated in FIG. 2, a control unit 20, which includes a central processing unit (CPU) 20A, a read-only memory (ROM) 20B, and a random-access memory (RAM) 20C. The CPU 20A controls the entire operation of the image forming device 12. The RAM 20C is used as a work area or the like when the CPU 20A executes various programs. The ROM 20B stores in advance various control programs, various parameters, and the like. In the image forming device 12, the individual parts of the control unit 20 are electrically connected by a system bus 42.

The image forming device 12 according to the present exemplary embodiment also includes a hard disk drive (HDD) 26, which stores various types of data, application programs, and the like. The image forming device 12 further includes a display controller 28, which is connected to a user interface 22 and which controls displaying of various operation screens on a display of the user interface 22. In addition, the image forming device 12 includes an operation input detector 30, which is connected to the user interface 22 and which detects operation instructions input via the user interface 22. In the image forming device 12, the HDD 26, the display controller 28, and the operation input detector 30 are electrically connected to the system bus 42. Although an example in which the image forming device 12 according to the present exemplary embodiment includes the HDD 26 is discussed, this is not the only possible case, and the image forming device 12 may include a non-volatile memory such as flash memory.

Moreover, the image forming device 12 according to the present exemplary embodiment includes a reading controller 32, which controls the optical image reading operation of a document reader 46 and the document feed operation of a document feeder, and an image formation controller 34, which controls the image formation processing performed by an image forming unit 24 and the feeding of paper to the image forming unit 24 by a feeder 25. The image forming device 12 also includes a communication interface (communication I/F) unit 36, which is connected to the internal communication line 17 and which transmits and receives communication data to and from other devices connected to the internal communication line 17, and an image processor 44, which performs various types of image processing. Moreover, the image forming device 12 includes a facsimile interface (facsimile I/F) unit 38, which is connected to a phone line (not illustrated) and which transmits and receives facsimile data to and from facsimile machines connected to the phone line. The image forming device 12 also includes a transmission/reception controller 40, which controls transmission and reception of facsimile data via the facsimile interface unit 38. In the image forming device 12, the transmission/reception controller 40, the reading controller 32, the image formation controller 34, the communication line interface unit 36, the facsimile interface unit 38, and the image processor 44 are electrically connected to the system bus 42.

With the above configuration, the image forming device 12 according to the present exemplary embodiment executes, with the CPU 20A, access to the RAM 20C, the ROM 20B, and the HDD 26. Furthermore, the image forming device 12 executes control of, with the CPU 20A, displaying of information such as operation screens and various messages on the display of the user interface 22 via the display controller 28. The image forming device 12 also executes control of, with the CPU 20A, the operation of the document reader 46 and the document feeder via the reading controller 32. In addition, the image forming device 12 controls, with the CPU 20A, the operation of the image forming unit 24 and the feeder 25 via the image formation controller 34, and the transmission and reception of communication data via the communication line interface unit 36. In addition, the image forming device 12 executes control of, with the CPU 20A, the transmission and reception of facsimile data by the transmission/reception controller 40 via the facsimile interface unit 38. Furthermore, the image forming device 12 grasps, with the CPU 20A, operation contents of the user interface 22 based on operation information detected by the operation input detector 30, and executes various types of control based on the operation contents. Note that forming an image on paper may be referred to as printing.

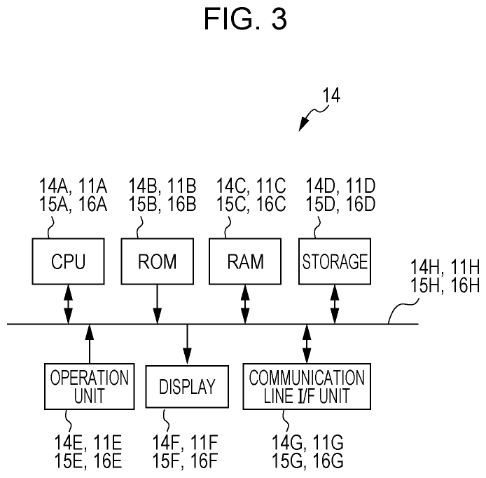

Next, the configuration of the major parts of the electrical system of the local server 11, the cloud server 14, the client terminal 15, and the communication terminal 16 in the image forming system 10 according to the present exemplary embodiment will be described. FIG. 3 is a block diagram illustrating the configuration of the major parts of the electrical system of the local server 11, the cloud server 14, the client terminal 15, and the communication terminal 16 according to the present exemplary embodiment. Since the local server 11, the cloud server 14, the client terminal 15, and the communication terminal 16 basically have the configuration of a general computer, the cloud server 14 will be described as a representative while omitting the description of the local server 11, the client terminal 15, and the communication terminal 16, and only corresponding reference symbols are indicated in FIG. 3.

The cloud server 14 according to the present exemplary embodiment includes, as illustrated in FIG. 3, a CPU 14A, a ROM 14B, a RAM 14C, a storage 14D, an operation unit 14E, a display 14F, and a communication line interface (I/F) unit 14G. The CPU 14A controls the entire operation of the cloud server 14. The ROM 14B stores in advance an information processing program for performing various types of control, various parameters, and the like. The RAM 14C is used as a work area or the like when the CPU 14A executes various programs. The storage 14D stores various types of data, application programs, and the like. The operation unit 14E is used for inputting various types of information. The display 14F is used for displaying various types of information. The communication line interface unit 14G is connected to the external communication line 18, and transmits and receives various types of data to and from other devices connected to the external communication line 18. The above units of the cloud server 14 are electrically connected to each other by a system bus 14H. The cloud server 14 according to the present exemplary embodiment includes the storage 14D as a memory, and a non-volatile memory such as an HDD or flash memory is applied as the storage 14D. Note that communication line interface units 11G, 15G, and 16G of the local server 11, the client terminal 15, and the communication terminal 16 are connected to the internal communication line 17 and transmit and receive various types of data to and from other devices connected to the internal communication line 17.

With the above configuration, the cloud server 14 according to the present exemplary embodiment executes, with the CPU 14A, access to the ROM 14B, RAM 14C, and storage 14D, obtaining of various types of data via the operation unit 14E, and displaying of various types of information on the display 14F. The cloud server 14 also executes control of, with the CPU 14A, the transmission and reception of communication data via the communication line interface unit 14G.

In the image forming system 10 according to the present exemplary embodiment configured as above, for example, the local server 11, the image forming device 12, and the client terminal 15 are provided in the company. Then, the use of the image forming device 12 is allowed from the outside using the communication terminal 16 via the cloud server 14.

The cloud server 14 provides the function of a virtual device that functions as the image forming device 12 in conjunction with the image forming device 12. That is, in the image forming system 10 according to the present exemplary embodiment, the CPU 14A on the cloud server 14 side functions as a virtual device that is provided one-to-one with a physical device, and that mediates the transmission and reception of information between an application and the physical device. In the following description, the image forming device 12 as an example of a physical device may be referred to as a real device 12.

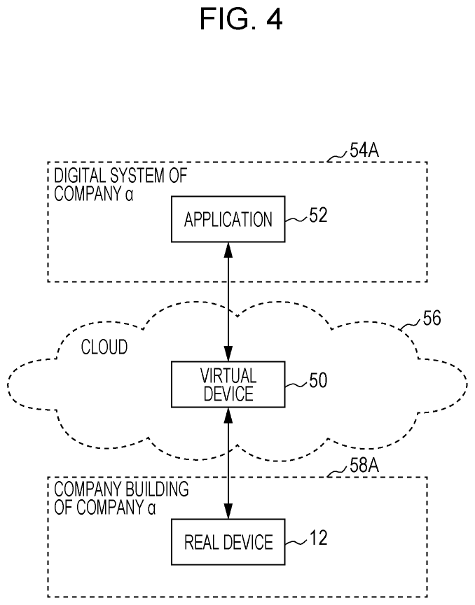

A virtual device is a modeled device that enables the retention or execution of functions that extend the functions of the real device 12 in conjunction with the real device 12. For example, as illustrated in FIG. 4, an application 52 installed in an information processing terminal such as the client terminal 15 or the communication terminal 16 belonging to a digital system 54A of Company α and the real device 12 installed in a company building 58A of Company a exchange information via a virtual device 50 located on a cloud 56.

The virtual device 50 synchronizes with the real device 12 with predetermined timing. An example of data to be synchronized includes meta data such as log data, status data, setting information, and machine information including a device name and a model name. When the virtual device 50 and the real device 12 are synchronized, it becomes possible to remotely view the status or change the settings of the real device 12 using the client terminal 15, the communication terminal 16, or the like.

Moreover, the virtual device 50 performs processing with external services via an application programming interface (API). Examples of external services include a machine management service and a printing service.

The machine management service allows a machine administrator who is at a different office or in a different country to access the machine management service to check the status or change the settings of the machine. The machine management service transmits and receives information to and from the virtual device 50. When the machine management service sends a status checking request to the virtual device 50, the virtual device 50 returns the status information. When the machine management service sends a setting change request to the virtual device 50, the virtual device 50 updates the setting information. When synchronized with the virtual device 50, the real device 12 obtains the updated setting information and changes the settings of the real device 12.

The printing service allows a mobile terminal such as the communication terminal 16 to upload print data to the printing service, and prints it on the real device 12 having obtained a print job via the virtual device 50.

Now, consider that a new real device 12 will be installed at a customer. The real device 12 and the virtual device 50 communicate with each other by identifying each other based on an identifier such as a serial number for uniquely identifying the real device 12. Because the virtual device 50 is on the cloud 56, the virtual device 50 is able to connect with the application 52 wherever the real device 12 is, which enables the application 52 and the real device 12 to exchange information.

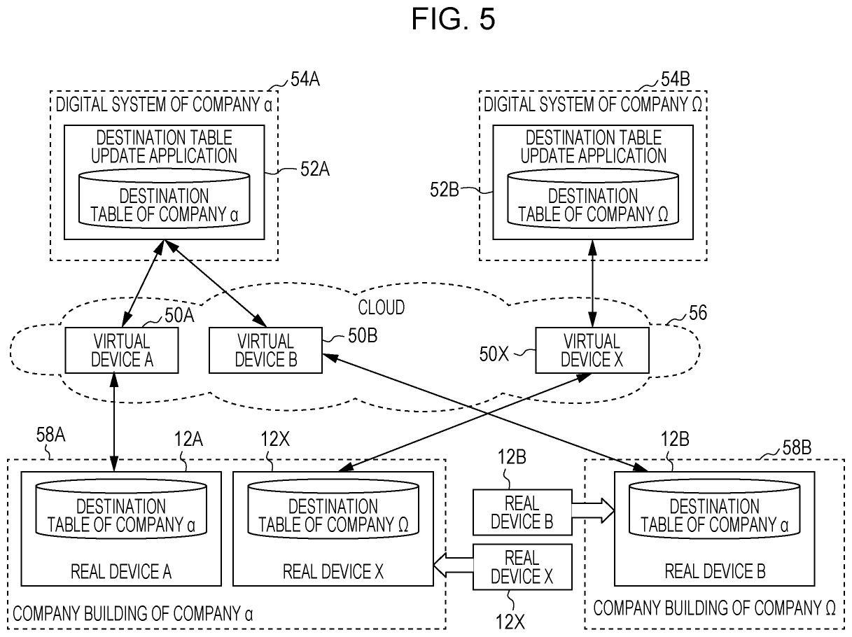

FIG. 5 is a diagram illustrating a situation where a real device B 12B, which is prepared to be installed at Company α, and a real device X 12X, which is prepared to be installed at Company Ω, are mistakenly replaced and installed.

When the real device X 12X is turned on at Company α, the real device X 12X performs data synchronization with a virtual device X 50X. At this time, when a destination table update application 52B in a digital system 54B at Company Ω performs update work of a destination table of Company Ω on the virtual device X 50X, the destination table of Company Ω is saved in the virtual device X 50X, and, when data is synchronized between the real device X 12X and the virtual device X 50X, the destination table of Company Ω is transferred to the real device X 12X. As a result, information leakage occurs in which employees of Company α will see the destination table of Company Ω, which is private information.

Accordingly, in the present exemplary embodiment, the cloud server 14 functions as the virtual device 50 mediating the transmission and reception of information between the application 52 and the real device 12, and, if the transmission and reception of information is set to unapproved in the virtual device 50, the transmission and reception of information to and from other applications other than a connection-approved application 52S whose connection with the virtual device 50 is approved in advance is prohibited.

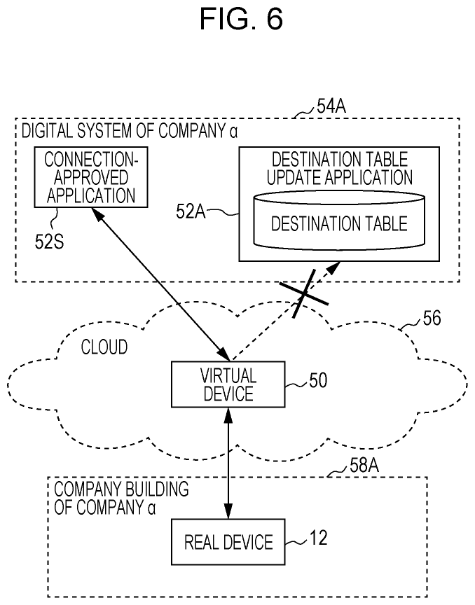

Here, processing performed by the virtual device 50 of the present exemplary embodiment will be described with reference to an exemplary case where a new real device 12 is installed at Company α. FIG. 6 is a diagram for explaining processing performed by the virtual device 50 in the case where a new real device 12 is installed at Company α.

FIG. 6 illustrates a state immediately after the virtual device 50 is prepared in the cloud server 14 before the real device 12 is installed at Company α, and then the real device 12 is installed at Company α as planned.

The real device 12 and the virtual device 50 recognize each other and communicate with each other based on, for example, a device serial number. The virtual device 50 and the digital system 54A of Company α also recognize each other and communicate with each other based on, for example, network addresses given to them.

Firstly, the virtual device 50 corresponding to the real device 12 to be installed at Company α is prepared on the cloud 56. The status stored in the virtual device 50 is set to unapproved. At Company α, the address of the connection-approved application 52S at Company α is registered with the virtual device 50. In addition, preparation is done to use the virtual device 50 from a group of applications at Company α.

Since the status set in the virtual device 50 is unapproved, communication is limited only to communication with the connection-approved application 52S. The connection-approved application 52S may be able to transfer to the virtual device 50 information necessary for the initial settings of the virtual device 50. In FIG. 6, the dotted line between the virtual device 50 and a destination table update application 52A indicates that communication is not permitted. For example, since a connection with the destination table update application 52A has not been permitted, no user information such as a destination table will be transferred to the device from the destination table update application 52A.

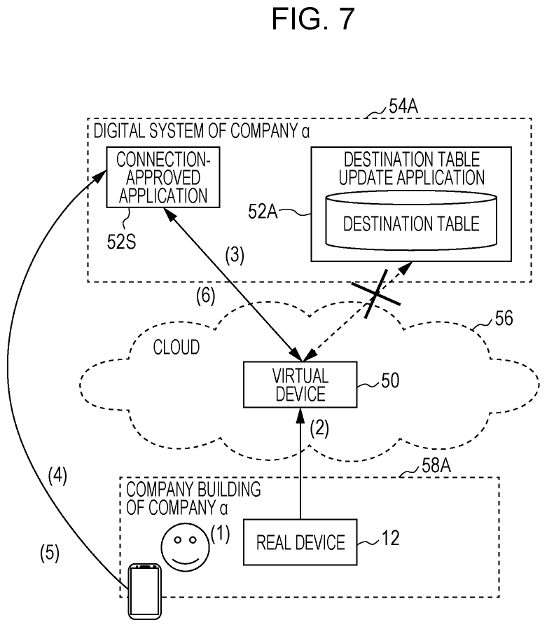

Next, a procedure for allowing the real device 12 to be usable from the digital system 54A of Company α will be described. FIG. 7 is a diagram for explaining a procedure for allowing the real device 12 to be usable from the digital system 54A of Company α.

Once the real device 12 is installed in the company building of Company α, the real device 12 is made usable from the digital system 54A of Company α by following the following procedure.
(1) The administrator at Company α operates the real device 12 in front of the administrator to give an instruction to start a connection.
(2) The real device 12 generates a random personal identification number (PIN) code and displays it on an operation panel of the user interface 22 or the like, and the real device 12 communicates an instruction to the virtual device 50 to start a connection using, as a parameter, the PIN code as an example of code information.
(3) On receipt of the instruction, the virtual device 50 requests the connection-approved application 52S at Company α to approve the virtual device 50, with the PIN code transmitted from the real device 12.
(4) Having received the request for approval, the connection-approved application 52S at Company α sends a notice to, for example, the communication terminal 16 of the administrator at Company α, which has been registered in advance, and asks the administrator whether to permit the connection.
(5) The administrator at Company α enters the PIN code, displayed on the operation panel of the real device 12, into the connection-approved application 52S and returns an instruction of permission.
(6) Having confirmed that the PIN code returned from the administrator at Company α and the PIN code transmitted from the virtual device 50 match, the connection-approved application 52S instructs the virtual device 50 to change the stored status from unapproved to approved.

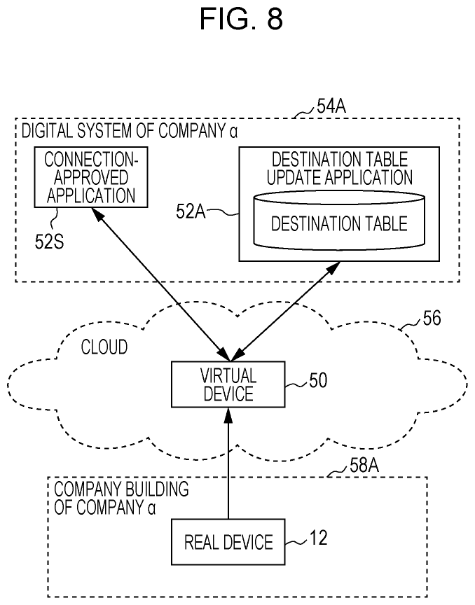

This enables the destination table update application 52A to communicate with the real device 12 and transmit the destination table to the real device 12. FIG. 8 is a diagram illustrating a state in which the virtual device 50 and the destination table update application 52A are enabled to communicate with each other and the destination table is transmitted to the real device 12. Only after the administrator at Company α confirms that the real device 12 has actually been installed in a safe location, private information such as a destination table is transmitted from an application at Company α to the real device 12.

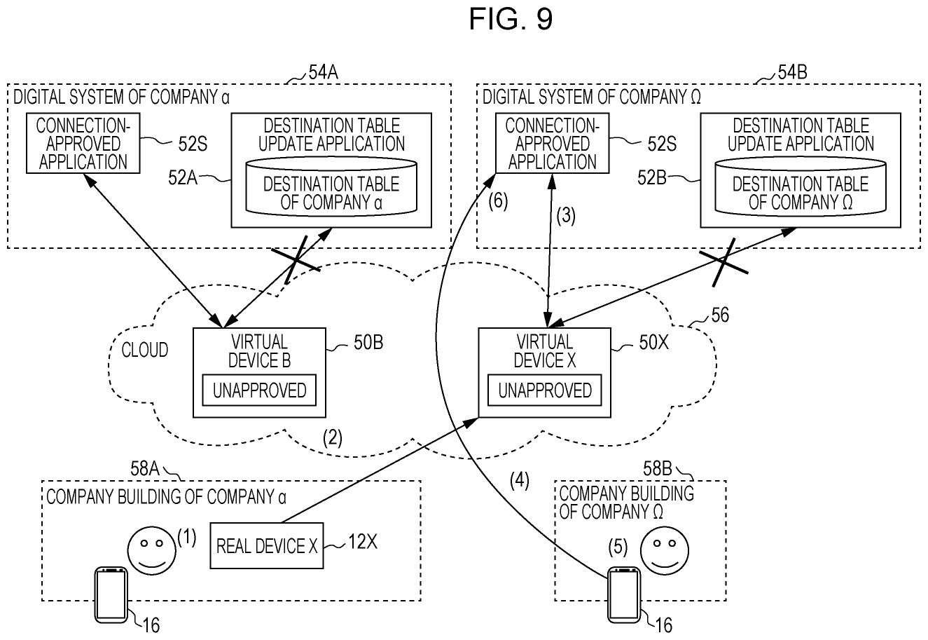

Next, the case in which, although a virtual device B corresponding to a real device B is prepared in the cloud server 14 before the real device B is installed at Company α, a real device X prepared to be installed at Company Ω is accidentally brought into Company α will be described. FIG. 9 is a diagram illustrating the case in which the real device X 12X, which is prepared to be installed at Company Ω, is accidentally brought into Company α.

The real device X 12X and the virtual device X 50X are prepared for Company Ω, and the real device X 12X and the virtual device X 50X are set to be able to recognize each other and communicate with each other based on a device serial number or the like. In the virtual device X 50X, the connection-approved application 52S at Company Ω is registered in advance, and the virtual device X 50X is stored as unapproved.

When the real device X 12X is unintentionally installed in the company building 58A of Company α, processing is performed by following the following procedure.
(1) The administrator at Company α operates the real device X 12X in front of the administrator to give an instruction to start a connection.
(2) The real device X 12X generates a random PIN code and displays it on the operation panel of the user interface 22, and the real device X 12X communicates an instruction to the virtual device X 50X to start a connection using the PIN code as a parameter.
(3) On receipt of the instruction, the virtual device X 50X requests the connection-approved application 52S at Company Ω to approve a virtual device B 50B, with the PIN code transmitted from the real device X 12X.
(4) Having received the request for approval, the connection-approved application 52S at Company Ω sends a notice to, for example, the communication terminal 16 of the administrator at Company Ω, which has been registered in advance, and asks the administrator whether to permit the connection.
(5) The administrator at Company Ω receives the unintended notice from the connection-approved application 52S at Company Ω, and returns an instruction of non-permission. The administrator at Company Ω does not know the PIN code displayed on the real device X 12X in the company building 58A of Company α, and therefore is unable to give an instruction of permission.
(6) On receipt of the instruction of non-permission, the connection-approved application 52S at Company Ω leaves the status stored in the virtual device X 50X as unapproved. The destination table of Company Ω is not transmitted from the destination table update application 52B at Company Ω to the real device X 12X.

Accordingly, unintentional transmission of private data, such as a destination table, from an application to the real device 12 installed in an unintended location may be prevented.

Based on the fact that there is no inquiry from the connection-approved application 52S at Company α, the administrator at Company α is able to recognize that the real device 12 in front of the administrator is not the real device B 12B planned to be installed.

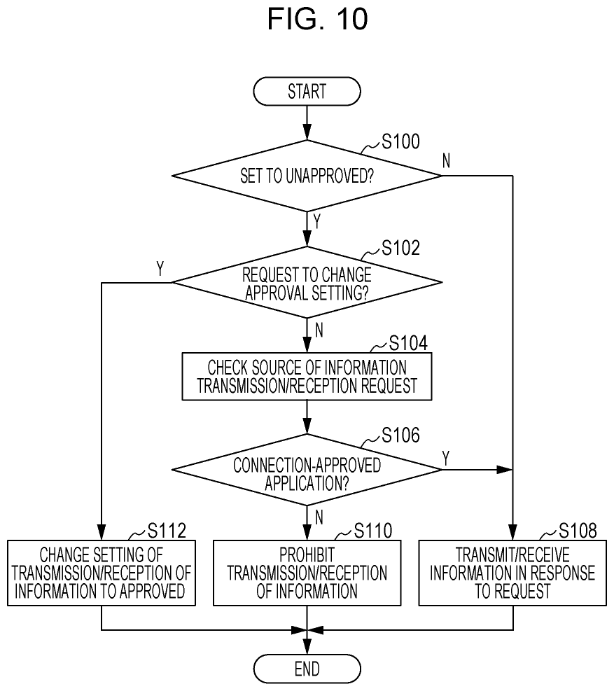

Next, specific processing performed by the cloud server 14 in the image forming system 10 according to the present exemplary embodiment configured as above will be described. FIG. 10 is a flowchart illustrating an example of the flow of processing performed by the cloud server 14 in the image forming system 10 according to the present exemplary embodiment. Note that the processing illustrated in FIG. 10 starts when, for example, the cloud server 14 accepts a request to transmit/receive information.

In step S100, the CPU 14A determines whether the set status is unapproved. The determination is performed by determining whether communication with other applications other than the connection-approved application 52S is set to unapproved. When the determination is affirmative, the CPU 14A proceeds to step S102, and, when the determination is negative, the CPU 14A proceeds to step S108.

In step S102, the CPU 14A determines whether a request to change the approval setting has been made. The determination is performed by determining, for example, whether the connection-approved application 52S has received confirmation information indicating that a PIN code returned from the administrator and a PIN code transmitted from the virtual device 50 match. When the determination is negative, the CPU 14A proceeds to step S104, and, when the determination is affirmative, the CPU 14A proceeds to step S112.

In step S104, the CPU 14A checks the source of the information transmission/reception request, and proceeds to step S106. That is, the CPU 14A checks whether the source of the information transmission/reception request is the connection-approved application 52S or another application.

In step S106, the CPU 14A determines whether the source of the information transmission/reception request is the connection-approved application 52S. When the determination is affirmative, the CPU 14A proceeds to step S108, and, when the determination is negative, the CPU 14A proceeds to step S110.

In step S108, the CPU 14A transmits/receives information in response to the request, and ends the series of steps of the processing.

In step S110, since the source of the information transmission/reception request is not the connection-approved application 52S, the CPU 14A prohibits the transmission and reception of information, and ends the series of steps of the processing.

In contrast, when a request to change the approval setting is made in step S102 and the CPU 14A proceeds to step S112, the CPU 14A changes the setting of the transmission and reception of information to approved, and ends the series of steps of the processing.

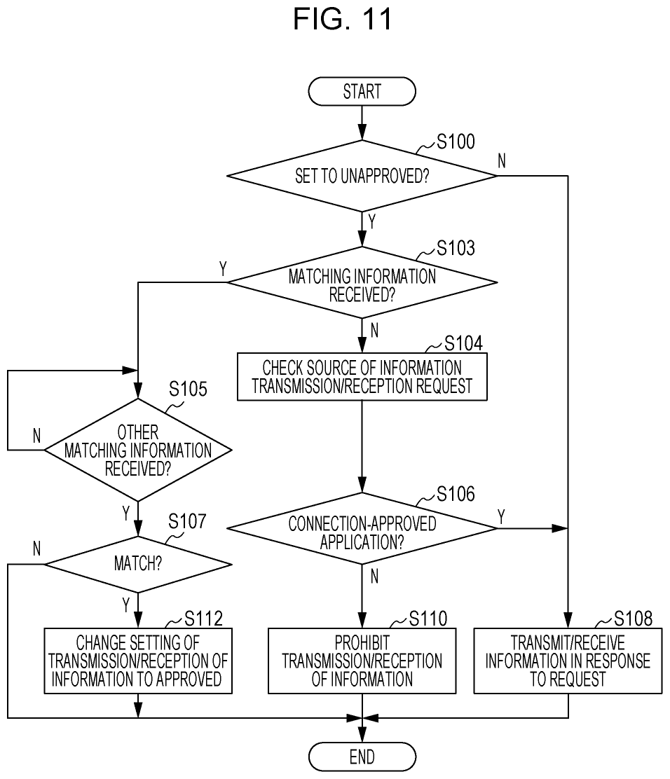

Although the example in which the connection-approved application 52S checks whether a PIN code transmitted from the communication terminal 16 and a PIN code transmitted from the real device 12 match has been described in the above exemplary embodiment, this is not the only possible case. For example, the virtual device 50 may check whether the PIN codes match. In this case, processing illustrated in FIG. 11 is performed. FIG. 11 is a flowchart illustrating an example of the flow of a modification of the processing performed by the cloud server 14 in the image forming system 10 according to the present exemplary embodiment. Note that steps that are common to those in FIG. 10 are denoted by the same reference symbols and described.

In step S100, the CPU 14A determines whether the set status is unapproved. The determination is performed by determining whether communication with other applications other than the connection-approved application 52S is set to unapproved. When the determination is affirmative, the CPU 14A proceeds to step S103, and, when the determination is negative, the CPU 14A proceeds to step S108.

In step S103, the CPU 14A determines whether matching information has been received. The determination is performed by determining, for example, whether matching information such as a PIN code has been received from the real device 12 or from the communication terminal 16 via the connection-approved application 52S. When the determination is negative, the CPU 14A proceeds to step S104, and, when the determination is affirmative, the CPU 14A proceeds to step S105.

In step S104, the CPU 14A checks the source of the information transmission/reception request, and proceeds to step S106. That is, the CPU 14A checks whether the source of the information transmission/reception request is the connection-approved application 52S or another application.

In step S106, the CPU 14A determines whether the source of the information transmission/reception request is the connection-approved application 52S. When the determination is affirmative, the CPU 14A proceeds to step S108, and, when the determination is negative, the CPU 14A proceeds to step S110.

In step S108, the CPU 14A transmits/receives information in response to the request, and ends the series of steps of the processing.

In step S110, since the source of the information transmission/reception request is not the connection-approved application 52S, the CPU 14A prohibits the transmission and reception of information, and ends the series of steps of the processing.

In contrast, when matching information is received in step S103, thus the determination being affirmative, and the CPU 14A proceeds to step S105, the CPU 14A determines whether other matching information has been received. In this determination, when matching information is received from the real device 12 in step S103, the CPU 14A waits until receiving matching information from the connection-approved applications 52S, and then proceeds to step S107. When matching information has been received from the connection-approved application 52S in step S103, the CPU 14A waits until receiving matching information from the real device 12, and then proceeds to step S107.

In step S107, the CPU 14A determines whether the matching information received from the real device 12 and the matching information received from the connection-approved application 52S match. The determination is performed by determining, for example, whether matching information such as a PIN code received from the real device 12 and matching information such as a PIN code received from the connection-approved application 52S match. When the determination is affirmative, the CPU 14A proceeds to step S112, and, when the determination is negative, the CPU 14A ends the series of steps of the processing as it is.

In step S112, the CPU 14A changes the setting of the transmission and reception of information to approved, and ends the series of steps of the processing.

Although PIN codes are used as examples of code information in the present exemplary embodiment, in addition to PIN codes, information for identifying the real device 12 may be applied as confirmation information.

Although the image forming device 12 has been described as an example of a physical device in the above exemplary embodiment, a physical device is not limited to the image forming device 12. For example, another device such as an image processing device may be applied as a physical device.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, processing performed by each unit of the image forming system 10 according to the above exemplary embodiment may be processing performed by software, processing performed by hardware, or processing that combines both. Moreover, processing performed by each unit of the image forming system 10 may be stored as a program on a storage medium to be distributed.

The present disclosure is not limited to the above, and needless to say, in addition to the above, the present disclosure may be implemented in various modifications within a range not deviating from the gist thereof.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing device including:
a processor configured to:
   function as a virtual device that is provided one-to-one with a physical device and that mediates transmission and reception of information between an application and the physical device; and
   in a case where transmission and reception of information is set to unapproved in the virtual device, prohibit transmission and reception of information to and from another application other than a connection-approved application whose connection with the virtual device is approved in advance.
(((2)))

The information processing device according to (((1))), wherein the processor is configured to approve the prohibited transmission and reception of information on receipt of, from the connection-approved application, confirmation information indicating that it has been confirmed that the physical device is installed in a predetermined location.
(((3)))

The information processing device according to (((1))), wherein the processor is configured to approve the prohibited transmission and reception of information in a case where confirmation information transmitted from the physical device and confirmation information transmitted from a user of the physical device via the connection-approved application match.
(((4)))

The information processing device according to (((3))), wherein the processor is configured to approve the prohibited transmission and reception of information in a case where code information generated in advance by the physical device is received as the confirmation information and code information matching the received code information is received from the connection-approved application.
(((5)))

The information processing device according to any one of (((1))) to (((4))), wherein the processor is configured to prohibit transmission and reception of information regarding a user.
(((6)))

An information processing system including:
the information processing device according to any one of (((1))) to (((5)));
the physical device; and
an information processing terminal in which the application has been installed.

A program causing a computer to execute a process for information processing, the process including:
functioning as a virtual device that is provided one-to-one with a physical device and that mediates transmission and reception of information between an application and the physical device; and
in a case where transmission and reception of information is set to unapproved in the virtual device, prohibiting transmission and reception of information to and from another application other than a connection-approved application whose connection with the virtual device is approved in advance.

What is claimed is:

1. An information processing device comprising:
a processor configured to:
function as a virtual device that is provided one-to-one with a physical device and that mediates transmission and reception of information between an application and the physical device; and
in a case where transmission and reception of information is set to unapproved in the virtual device, prohibit transmission and reception of information to and from another application other than a connection-approved application whose connection with the virtual device is approved in advance.

2. The information processing device according to claim 1, wherein the processor is configured to approve the prohibited transmission and reception of information on receipt of, from the connection-approved application, confirmation information indicating that it has been confirmed that the physical device is installed in a predetermined location.

3. The information processing device according to claim 1, wherein the processor is configured to approve the prohibited transmission and reception of information in a case where confirmation information transmitted from the physical device and confirmation information transmitted from a user of the physical device via the connection-approved application match.

4. The information processing device according to claim 3, wherein the processor is configured to approve the prohibited transmission and reception of information in a case where code information generated in advance by the physical device is received as the confirmation information and code information matching the received code information is received from the connection-approved application.

5. The information processing device according to claim 1, wherein the processor is configured to prohibit transmission and reception of information regarding a user.

6. An information processing system comprising:
the information processing device according to claim 1;
the physical device; and
an information processing terminal in which the application has been installed.

7. A non-transitory computer readable medium storing an information processing program causing a computer to execute a process, the process comprising:
functioning as a virtual device that is provided one-to-one with a physical device and that mediates transmission and reception of information between an application and the physical device; and
in a case where transmission and reception of information is set to unapproved in the virtual device, prohibiting transmission and reception of information to and from another application other than a connection-approved application whose connection with the virtual device is approved in advance.

8. An information processing method for a computer to execute a process, the process comprising:
functioning as a virtual device that is provided one-to-one with a physical device and that mediates transmission and reception of information between an application and the physical device; and
in a case where transmission and reception of information is set to unapproved in the virtual device, prohibiting transmission and reception of information to and from another application other than a connection-approved application whose connection with the virtual device is approved in advance.
